(19) United States
(12) Patent Application Publication
(10) Pub. No.: US 2003/0058517 A1
(43) Pub. Date: Mar. 27, 2003

(54) High contrast reflective LCD for telecommunications applications

(76) Inventors: Robert G. Lindquist, Elmira, NY (US); John P. Kondis, Costa Mesa, CA (US); Yimin Ji, Hudson, OH (US); Rui-Qing Ma, Painted Post, NY (US)

Correspondence Address: Price, Heneveld, Cooper, DeWitt & Litton, 695 Kenmoor, S.E., Post Office Box 2567, Grand Rapids, MI, 49501, US

(21) Appl. No.: 10/121,453

(22) Filed: Apr. 12, 2002

Related U.S. Application Data
(60) Provisional application No. 60/283,756, filed on Apr. 13, 2001.

(51) Int. Cl. G02F 1/03; G02F 1/07

(52) U.S. Cl. 359/247

(57) ABSTRACT

An optical system of the present invention includes a reflective liquid crystal device having a plurality of independently activated liquid crystal elements, and an optical element for directing a plurality of input light beams at the reflective liquid crystal device such that each input light beam impinges upon one of the liquid crystal elements. Each liquid crystal element of the reflective liquid crystal device includes a transparent first electrode, a reflective second electrode spaced apart from the first electrode, and a liquid crystal medium disposed between the first and second electrodes. The liquid crystal elements are independently operable to change between half-wave and zero retardation states in response to an applied voltage.

### CROSS-REFERENCE TO RELATED APPLICATIONS

This application claims the benefit of priority under 35 U.S.C. §119(e) for U.S. Provisional Patent Application No. 60/283,756 entitled “HIGH CONTRAST REFLECTIVE LCD FOR TELECOM APPLICATIONS,” filed on Apr. 13, 2001, the entire disclosure of which is incorporated herein by reference.

### BACKGROUND OF THE INVENTION

1. Field of the Invention

The present invention relates to an optical system including a liquid crystal device, and more particularly relates to an optical system having a liquid crystal device for use in telecommunications applications.

2. Technical Background

In the past two decades, fiberoptics have transformed the telecommunications marketplace. Initially, network designs included relatively low speed transceiver electronics at each end of the communications link. Light signals were switched by being converted into electrical signals, switched electronically, and reconverted into light signals. The bandwidth of electronic switching equipment is limited to about 10 GHz. On the other hand, the bandwidth of single mode optical fibers in the 1550 nm region of the electromagnetic spectrum is in the Terahertz range. As the demand for bandwidth increases exponentially, network designers have sought ways to exploit the available bandwidth in the 1550 nm region.

Polarization dependent loss (PDL) and polarization mode dispersion (PMD) can severely degrade the quality of optical networking signals. As optical networking systems move to very high data rates, such as 10 Gbit/s and 40 Gbit/s, PDL and PMD become even more important. Therefore, optical systems and components with very low PMD and PDL are extremely valuable.

Several approaches to providing a wavelength selective switch (WSS) are disclosed in commonly assigned International Publication No. WO 01/01173 A1. This system utilizes a transmissive liquid crystal switch having an array of independently activated modulating elements.

None of the prior art optical systems, however, utilize a reflective geometry. The inventors have discovered that optical systems with reflective geometries have significantly reduced PMD and PDL. Accordingly, there exists a need for a reflective liquid crystal device that can be used in such optical systems.

### SUMMARY OF THE INVENTION

According to an embodiment of the present invention, an optical system comprises: a reflective liquid crystal device having a plurality of independently activated liquid crystal elements; and an optical element for directing a plurality of input light beams at the reflective liquid crystal device such that each input light beam impinges upon one of the liquid crystal elements. Each liquid crystal element of the reflective liquid crystal device comprises: a transparent first electrode; a reflective second electrode spaced apart from the first electrode; and a liquid crystal medium disposed between the first and second electrodes. The liquid crystal elements are independently operable to change between half-wave and zero retardation states in response to an applied voltage.

According to another embodiment of the present invention, a reflective liquid crystal device is provided for use in an optical communication system in which a plurality of input light beams are directed at the liquid crystal device. The liquid crystal device comprises: a transparent first substrate having a first surface upon which the at least one light beam is incident and a second surface opposite the first surface; a transparent first electrode layer supported on the second surface of the first substrate; a second substrate having first and second surfaces, the first surface of the second substrate being opposed to the second surface of the first substrate; a second electrode layer supported on the first surface of the second substrate, wherein the second electrode layer is either reflective or transparent if a reflective layer is otherwise supported by one of the surfaces of the second substrate; a first alignment layer supported on the second surface of the first substrate; a second alignment layer supported on the first surface of the second substrate; and a liquid crystal medium disposed between the first and second electrode layers. At least one of the first and second electrode layers is patterned so as to define a plurality of independently activated liquid crystal elements each sized to receive one of the input light beams. The liquid crystal elements are operable to change between half-wave and zero retardation states in response to an applied voltage.

According to another aspect of the present invention, an optical communication system comprises: a reflective liquid crystal device having a plurality of independently activated liquid crystal elements; and an optical element for directing a plurality of input light beams at the reflective liquid crystal device such that each input light beam impinges upon one of the liquid crystal elements. The reflective liquid crystal device comprises: a transparent first substrate having a first surface upon which a plurality of light beams are incident and a second surface opposite the first surface; a transparent first electrode layer supported on the second surface of the first substrate; a second substrate having first and second surfaces, the first surface of the second substrate being opposed to the second surface of the first substrate; a second electrode layer supported on the first surface of the second substrate, wherein the second electrode layer either is reflective or is transparent if a reflective layer is otherwise supported by one of the surfaces of the second substrate; a first alignment layer supported on the second surface of the first substrate; a second alignment layer supported on the first surface of the second substrate; and a liquid crystal medium disposed between the first and second electrode layers. At least one of the first and second electrode layers is patterned so as to define the plurality of independently activated liquid crystal elements. The liquid crystal elements are independently operable to change between half-wave and zero retardation states in response to an applied voltage.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

In the drawings:

FIG. 1 is a front elevational view of a reflective liquid crystal device constructed in accordance with the present invention;

FIG. 2 is a cross-sectional view of the reflective liquid crystal device shown in FIG. 1 taken along line 11-11;

FIGS. 3A through 3C are diagrams illustrating the orientation of the liquid crystal molecules within a device constructed in accordance with a first embodiment of the present invention at three respective voltage levels;

FIG. 4 is a perspective diagram illustrating the polarization states of an incident and reflected light beam according to a first implementation of the first and third embodiments of the present invention;

FIG. 5 is a graph of attenuation versus applied voltage for two different implementations of the first embodiment of the present invention;

FIG. 6 is a perspective diagram illustrating the polarization states of an incident and reflected light beam according to a second implementation of the various embodiments of the present invention;

FIG. 7 is a graph of attenuation versus applied voltage for two different implementations of the first embodiment of the present invention;

FIGS. 8A through 8C are diagrams illustrating the orientation of the liquid crystal molecules within a device constructed in accordance with a second embodiment of the present invention at three respective voltage levels;

FIG. 9 is a perspective diagram illustrating the polarization states of an incident and reflected light beam according to a first implementation of the second embodiment of the present invention;

FIG. 10 is a graph of attenuation versus applied voltage for two different implementations of the second embodiment of the present invention;

FIG. 11 is a graph of attenuation versus applied voltage for two different implementations of the second embodiment of the present invention;

FIGS. 12A through 12C are diagrams illustrating the orientation of the liquid crystal molecules within a device constructed in accordance with a third embodiment of the present invention at three respective voltage levels;

FIG. 13 is a graph of attenuation versus applied voltage for two different implementations of the third embodiment of the present invention;

FIG. 14 is a graph of attenuation versus applied voltage for two different implementations of the third embodiment of the present invention;

FIG. 15 is a diagram of a dynamic spectral equalizer utilizing the reflective LC device of the present invention;

FIG. 16 is a side view of a portion of the optical system shown in FIG. 15; and

FIG. 17 is a diagram of a dual dynamic spectral equalizer/wavelength selective switch utilizing the reflective LC device of the present invention.

### DETAILED DESCRIPTION OF THE PREFERRED EMBODIMENT

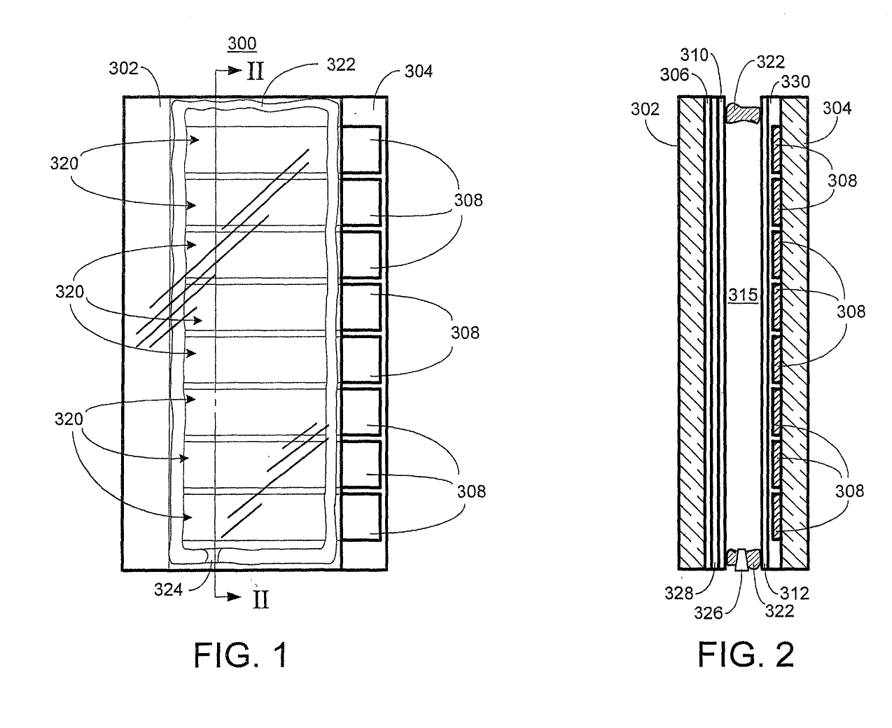

As noted above, the present invention generally pertains to an optical system including a reflective liquid crystal (LC) device, and more particularly relates to the reflective LC device itself as used in the optical system. FIGS. 1 and 2 show the general structure of the inventive reflective LC device 300. As will be explained further below, the same general physical structure is utilized for each of the three embodiments.

As illustrated in FIG. 1, reflective LC device 300 includes a transparent first substrate 302 having a first surface upon which at least one light beam is incident, and a second surface opposite the first surface. LC device 300 further includes a second substrate having first and second surfaces where the first surface of second substrate 304 is opposed to the second surface of first substrate 302. A transparent first electrode layer 306 (see FIG. 2) is supported on the second surface of first substrate 302. As used herein, the phrase “supported on” shall refer not only to situations where a supported layer is disposed directly on a supporting surface, but also where there are intermediate layers between the supported layer and the supporting surface/structure. A second electrode layer 308 is supported on the first surface of second substrate 304. The first alignment layer 310 is supported on the second surface of first substrate 302 while a second alignment layer 312 is supported on the first surface of second substrate 304. An LC medium 315 is disposed between first electrode layer 306 and second electrode layer 308. At least one of electrode layers 306 and 308 is patterned so as to define a plurality of independently activated liquid crystal elements 320, each sized to receive one of the input light beams. Second electrode layer 308 may be made of a reflective material or may be made of a transparent material depending upon whether second substrate 304 is otherwise already reflective or if second substrate 304 carries a reflective layer on one of its surfaces.

Liquid crystal elements 320 are preferably independently operable to change between half-wave and zero retardation states in response to an applied voltage. The manner in which this is accomplished is described further below with respect to the various embodiments. Second substrate 304 need not be transparent so long as electrodes 308 are reflective or so long as a reflective coating is otherwise provided on the first surface of second substrate 304. If substrate 304 is transparent and electrodes 308 are transparent, a reflective coating may be applied to the rear second surface of substrate 304. It should also be noted that electrodes 308 may be made of a single material, or may be made of a series of sublayers of different materials so as to enhance the adhesion of the electrode material to the second substrate or to the other layers of the device.

Referring to FIGS. 1 and 2, first substrate 302 is spaced apart from second substrate 304 and a seal 322 is provided about the periphery of the overlapping portions of substrates 302 and 304 to define a sealed chamber therebetween. Spacers (not shown) may be placed in seal 122 or elsewhere between substrates 302 and 304 to maintain uniform spacing. A small aperture 324 is provided in seal 122 so as to fill the chamber with the LC medium 315 using known vacuum-filling techniques. A UV-curable plug 326 may then be inserted into the hole to prevent leakage of the LC medium from the LC device.

As shown in FIG. 1, first substrate 302 may be laterally shifted with respect to second substrate 304 so as to expose the electrodes 306 and 308 for electrical coupling to a device driver circuit (not shown). This driver circuit would independently apply a voltage to the patterned electrodes and hence across each of the LC elements 320. As noted above, either electrode 306 or 308 may be patterned or alternatively both electrodes may be patterned. It will further be appreciated that each of the LC elements 320 may be independently sealed, if desired. In general, however, such independent sealing may not be required and may unduly complicate the manufacture of the device.

In each of the embodiments described below, the LC device may further include a first protection layer 328 disposed between first electrode 306 and LC medium 315. A similar second protection layer 330 may likewise be applied between electrodes 308 and LC medium 315. The protection layers serve to prevent the flow of electrons through LC medium 315.

The LC device described above and shown in FIGS. 1 and 2 may be made using the following procedure. First, an electrically conductive layer is deposited on each of the two substrates 302 and 304. The conductive layer applied to substrate 302 should be transmissive so as to provide a transparent electrically conductive electrode 306. Transparent electrically conductive layer 306 may be indium tin oxide (ITO) or any other suitable material. It should be noted that glass substrates coated with ITO are commercially available. The conductive layer applied to second substrate 304 is preferably reflective. Suitable materials include metals such as gold, white gold, silver, platinum, chromium, and alloys thereof.

Once the conductive layers are applied to substrates 302 and 304, one of the conductive layers may be patterned or alternatively both may be patterned to provide for a multi-pixel LC device. Both dry and wet etching techniques can be utilized.

After the electrodes 306 and 308 have been applied and patterned where necessary, protection layers 328 and 330 may be applied over electrodes 306 and 308, respectively. The protection layers prevent the electrons from the electrodes from getting into the LC medium 315 and also help the adhesion of the alignment chemical of alignment layers 310 and 312 to the electrodes. Suitable materials for protection layers 328 and 330 include alumina (Al₂O₃) and silica (SiO₂).

Subsequently, alignment layers 310 and 312 are deposited on protection layers 328 and 330, respectively. As noted below, the alignment layers may be either homeotropic or homogenous. For homogenous alignment layers, polyimide is a typical material to be deposited. For homeotropic alignment layers, copolymers, such as polymaleic anhydride-alt-1-octadecene, and certain kinds of polyimide (such as SE-1211), may be used. After the alignment layers are deposited, they are typically rubbed in order to provide the LC molecules with an orientational preference. For each of the embodiments described below, the two alignment layers 310 and 312 are rubbed in opposite directions at a 45 degree angle relative to the polarization of the incident and exiting light beams.

The next step is to dispense a mixture of glue and spacers on one of the substrates to form seal 122. The spacers may be spread out across the entire surface of the substrate to which the glue and spacer mixture is applied. These spacers may either be optically transparent or may be made of a material that will dissolve in the LC medium. The other substrate is then placed on top of the other substrate and the glue mixture is cured with a pressure applied on the sample to ensure the gap is the same size as the spacers. As noted above, an opening may be left in the glue pattern/seal 122 to allow dispersal of the LC medium within the otherwise sealed chamber. The LC medium can be vacuum-filled into the gap between the substrates. After the LC medium is filled, the opening can be plugged by glue or some other form of plug.

The LC devices of the present invention are preferably configured to have a relatively small viewing angle (approximately 4 degrees) and extremely high contrast ratio (greater than 10,000:1). LC devices exhibiting the small viewing angles and high contrast ratios are disclosed in commonly assigned U.S. patent application Ser. No. 09/429,135 and U.S. Provisional Patent Application No. 60/129,798, the disclosures of which are incorporated herein by reference. The LC devices disclosed in these applications are all transmissive. An additional desirable specification for the LC device of the present invention is for polarization dependent loss (PDL) to be less than 0.2 dB over all attenuation and switching configurations. This is attainable by utilizing a reflective-based geometry for the product design. As noted above, this may be achieved by utilizing reflective electrodes or other layers or substrates in the LC device.

With respect to contrast ratio, the limiting factor is reflections off the numerous index-bearing interfaces in the LC device. These reflections can be diminished by using anti-reflection (AR) coatings. However, in practice, some reflection will always exit and limit performance. However, if each undesired reflection had the identical polarization, the performance could be significantly improved using isolation techniques. A significant attribute in the cell designs discussed below is that the alignment layer is chosen such that a coating can be designed to minimize reflection and that the polarization of the reflection does not change. The inventors have discovered that the reflection off an isotropic layer (such as an AR coating) and a birefringent material (homogenous aligned LC) is a limiting factor. These reflections typically alter the polarization and limit performance. The LC device can appear to be isotropic with a homeotropic alignment layer. As described further below, each LC device of the three embodiments has two alignment layers. The LC device according to the first embodiment (hereinafter referred to as “electrically controlled birefringence (ECB)”) uses homogenous alignment for both. The LC device of the second embodiment (hereinafter referred to as “vertically aligned nematics (VAN)”) uses homeotropic alignment for both alignment layers. The LC device of the third embodiment (hereinafter referred to as “hybrid aligned nematic (HAN)”) uses one homeotropic and one homogenous alignment layer. As will be apparent to those skilled in the art, the VAN LC device would have the best contrast ratio followed by the HAN and finally the ECB LC device.

Another important attribute of an LC device is channel uniformity. Specifically, it is important that the LC device has uniform optical performance across at least the portion of each LC element 320 through which light is passed. This implies that the fringing field effect from neighboring LC elements 320 should be minimized. The ECB and HAN LC devices have excellent uniformity while the VAN LC device exhibits some uniformity degradation.

Overall, the HAN LC device provides the most desirable properties for the reflective cell geometry for the telecommunications application that is described below, since it is the best compromise of the various cell performance factors. However, each embodiment has its unique properties that may be advantageous for differing applications.

The chemical structure of liquid crystals is asymmetric and, as a result, their dielectric and optical properties are asymmetric as well. LC molecules exhibit birefringence and can be aligned by external fields. For example, when an electric field is applied to an LC medium with positive dielectric anisotropy, the LC molecules tend to align with the field, which results in rotation (or tilt) of the LC molecules. On the other hand, when an LC medium with a negative dielectric anisotropy is utilized and when an electric field is applied, the LC molecules tend to align perpendicularly to the field, which results in rotation (or tilt) of the LC molecules. LC devices can thus be used to make switchable wave-plates or wave-guides. The output intensity of light depends on the configuration and refractive indices of the components of the LC devices.

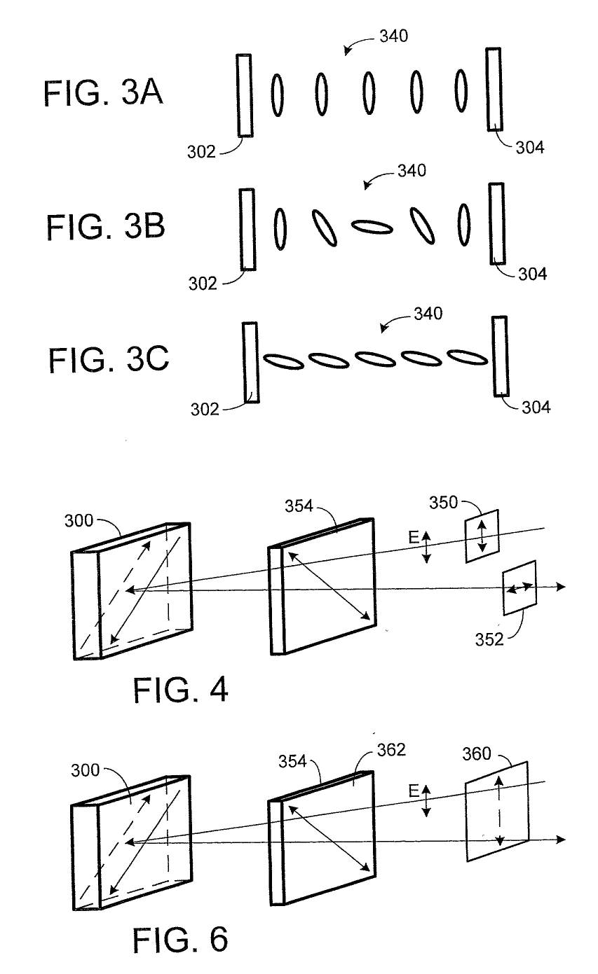

As stated above, the LC device of the first embodiment is an ECB LC device. Such an ECB LC device utilizes an LC medium 315 with a positive dielectric anisotropy and the alignment layers 310 and 312 are both homogenous. As shown in FIG. 3A, when no voltage is applied to electrodes 306 and 308, the LC molecules 340 are more or less parallel to the surfaces of the two substrates 302 and 304. With the right thickness, the LC device 300 of the first embodiment functions as a half-wave plate, which can rotate the incident polarization by 90 degrees when the LC molecular orientation in the substrate plane is 45 degrees with respect to the incident polarization. With an intermediate voltage applied, the LC molecules 340 in the middle begin to rotate, as shown in FIG. 3B. When a high voltage is applied, all the LC molecules 340, except at the surfaces, will align with the field and the LC device has basically zero retardation, as shown in FIG. 3C. Thus, when a high voltage is applied, the incident light will retain its initial polarization.

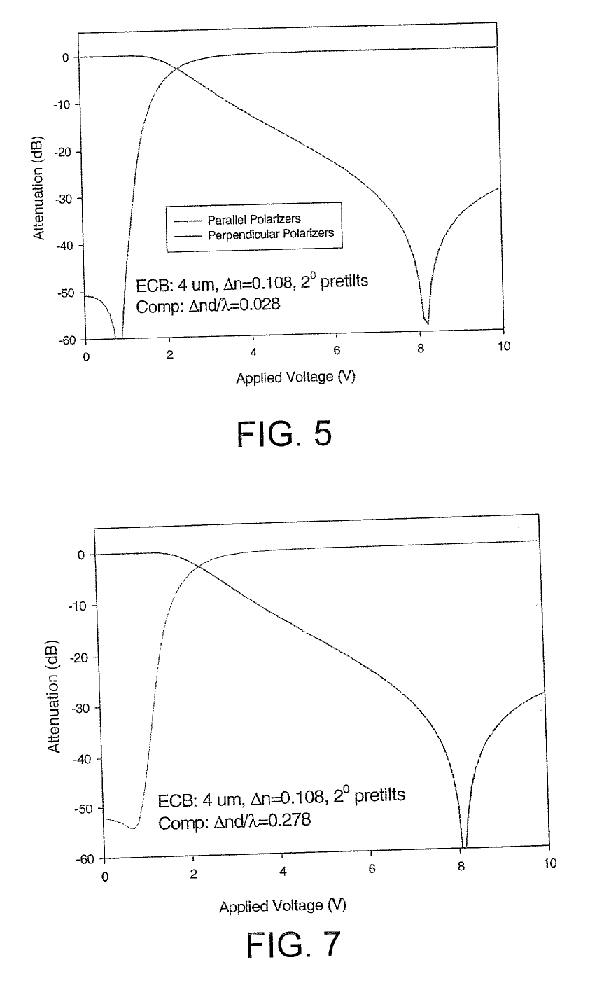

Alignment layers 310 and 312 are preferably deposited over the protection layers 328 and 330. For the ECB LC device of the third embodiment, the LC molecules 340 are preferably aligned parallel to the substrate surfaces when no voltage is applied. Polyimide is a typical choice for homogenous (parallel to the surface) alignment layers. When polyimide is used for homogenous alignment, it is preferably rubbed in order to give the LC molecules an orientation preference. One configuration of a reflective ECB LC device as an optical switch is shown in FIG. 4. As illustrated, reflective ECB LC device 300 has its homogenous alignment layers rubbed in opposite directions at a 45 degree angle relative to the polarization of the incident and exiting light beams. As illustrated in FIG. 4, two polarizers 350 and 352 are utilized. Polarizers 350 and 352 can have polarizations that are either parallel or perpendicular to each other. A birefringence medium 354 may be placed in front of LC device 300 to compensate for the residual birefringence when a high voltage is applied. As noted above, the reflective ECB LC device 300 is a half-wave retarder when no voltage is applied. The results of a simulation of the device used in the configuration shown in FIG. 4 is shown in FIG. 5 in cases where the polarizers 350 and 352 have their polarizations perpendicular and where they are parallel. As apparent from the graph shown in FIG. 5, attenuation of greater than 40 dB may be attained in one voltage state whereas virtually zero attenuation is attained in the other voltage state.

FIG. 6 shows an alternative configuration whereby instead of using two polarizers 350 and 352, a single polarizer 360 combined with a quarter-wave plate 362 is utilized. Quarter-wave plate 362 can further be combined and integrated with the compensation medium 354. The results of a simulation using this structure are illustrated in FIG. 7.

As shown in FIGS. 4 and 6, the slow axis of the compensating medium 354 is preferably 45 degrees relative to the polarization of the incident and reflected light and is perpendicular to the rub direction of the alignment layers of LC device 300.

As noted above, the LC device of the second embodiment is a VAN LC device including an LC medium 315 having a negative dielectric anisotropy, and including alignment layers 310 and 312 that are both homeotropic. The function of the homeotropic alignment layer is to give the LC molecules a preference of orientation that is close to perpendicular to the substrates. Examples of alignment chemicals, which give homeotropic alignment (perpendicular to a substrate) are copolymers, such as polymaleic anhydride-alt-1-octadecene, and certain kinds of polyimide (SE-1211). For a VAN LC device, in order to give the LC molecules 340 an orientational preference when a voltage is applied, at least one of the alignment layers should provide an alignment direction different from 90 degrees. One way to achieve this is to rub the polyimide. The polyimide may be rubbed in the same manner as disclosed with respect to the first embodiment.

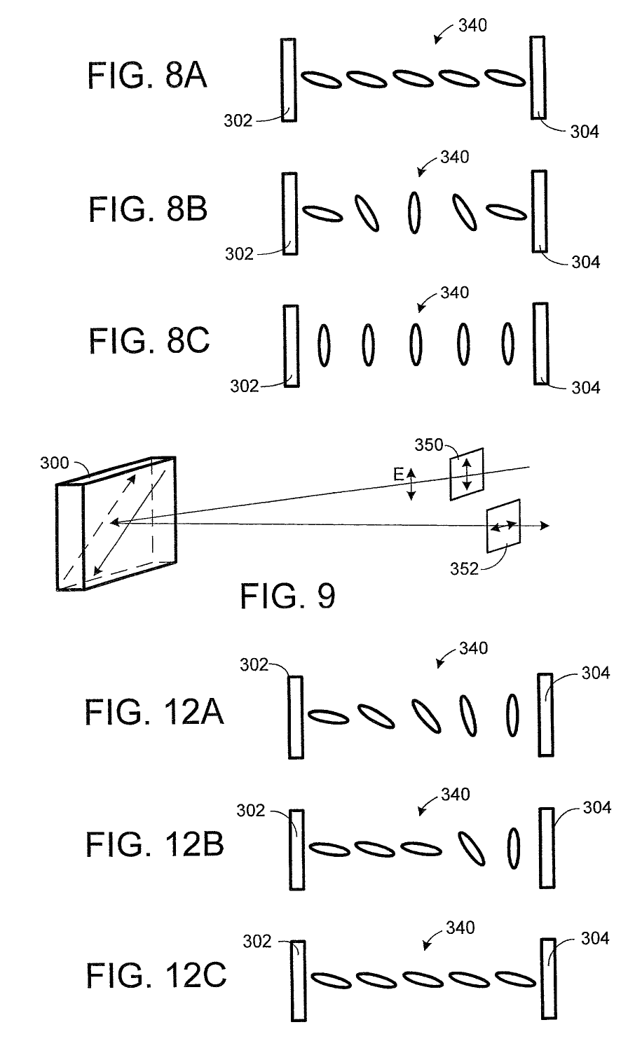

In the VAN LC device 300, when no voltage is applied, all the LC molecules 340 are aligned in one direction and close to perpendicular to substrates 302 and 304, as shown in FIG. 8A. The retardation of the system is close to zero when no voltage is applied and hence the polarization of the incident light will be maintained. When an intermediate voltage is applied, the LC molecules 340 in the middle of the LC medium 315 begin to rotate, as shown in FIG. 8B. When a high voltage is applied, all the LC molecules 340, except at the surfaces, will align perpendicular to the field as shown in FIG. 8C. With the right thickness, LC device 300 can function as a half-wave plate, which can rotate the incident polarization by 90 degrees when the LC molecules are aligned 45 degrees with respect to the incident polarization.

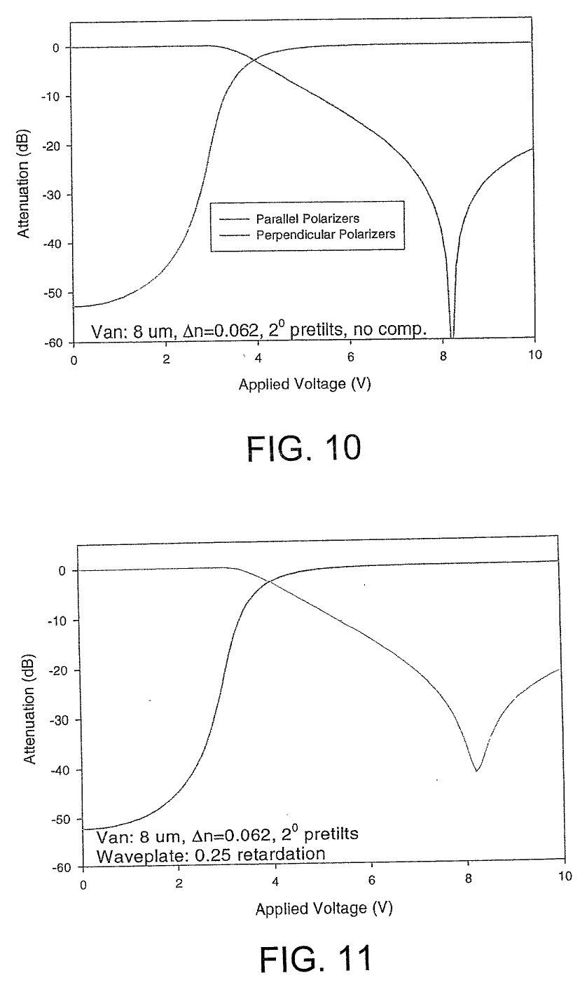

The configuration of the VAN LC device 300 as an optical switch is shown in FIG. 9 in which two polarizers 350 and 352 are utilized. Polarizers 350 can have their polarizations either parallel or perpendicular to each other. As noted above, the reflective VAN LC device 300 is a half-wave retarder when a high voltage is applied. The simulation results of the configuration shown in FIG. 9 are shown in FIG. 10.

Instead of using two polarizers 350 and 352, one polarizer 360 and a quarter-wave plate 362 may be utilized. Such a configuration is shown in FIG. 6. It should be noted, however, that for a VAN LC device, it may not be necessary to utilize, or combine the quarter-wave plate with, a compensating birefringence medium 354. The results of a simulation utilizing a structure similar to that shown in FIG. 6 but without a compensating birefringence medium 354 are shown in FIG. 11.

The third embodiment of the present invention is a hybrid ECB LC device (also referred to herein as an “HAN LC device”). In the HAN LC device, a liquid crystal medium 315 is used that has a positive dielectric anisotropy. In this embodiment, one of the alignment layers 310 and 312 is homogenous while the other is homeotropic. In the HAN LC device 300, when no voltage is applied, the LC molecules 340 are perpendicular to the surface at one substrate 302 and parallel to the surface at the other substrate 304. The orientation of the LC molecules 340 exhibits a gradual transition from one surface to the other as shown in FIG. 12A. With the right thickness, the HAN LC device 300 functions as a half-wave plate, which can rotate the incident polarization by 90 degrees when the LC molecular orientation in the substrate plane is 45 degrees with respect to the incident polarization. Such an orientation is attained by rubbing the alignment layers in a direction similar to that shown in FIGS. 4 and 6. With an intermediate voltage applied, the LC molecules 340 in the middle off LC medium 340 begin to rotate as shown in FIG. 12B. When a high voltage is applied, all the LC molecules 340, except at the surfaces, will align with the field and the LC device has basically zero retardation, as shown in FIG. 12C. Thus, when a high voltage is applied, the polarization of the incident light is maintained.

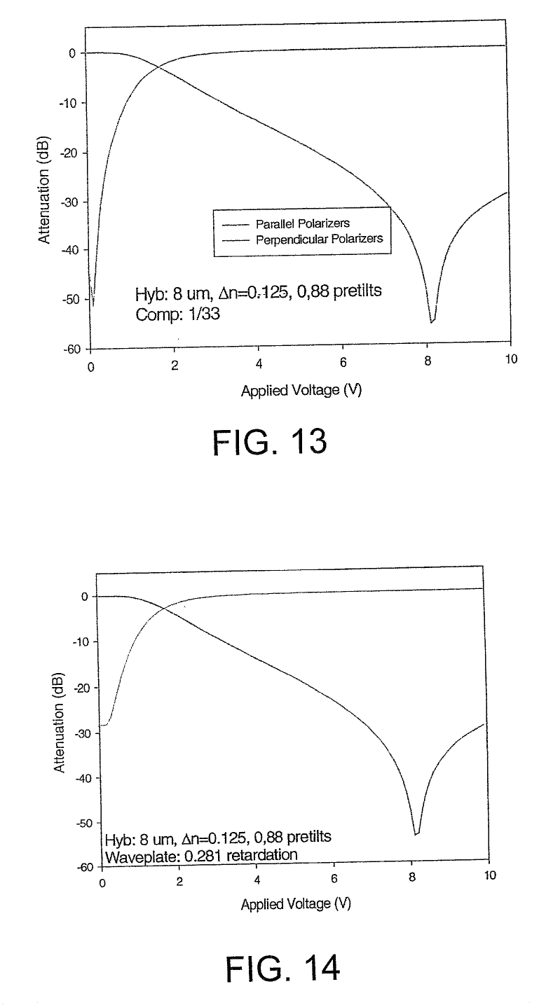

The HAN LC device 300 may be utilized in either of the configurations shown in FIGS. 4 or 6. A simulation with the HAN LC device 300 as used in the configuration of FIG. 4 is shown in FIG. 13 whereas the results of a simulation using the third embodiment in the configuration of FIG. 6 is shown in FIG. 14.

The LC devices disclosed above are advantageous in that they have little or no incident angle-dependent loss, they can attenuate to greater than 40 dB, and can be constructed to have a fairly small size. The devices disclosed above may be used in various optical applications, particularly telecommunications applications, as described further below.

Examples of optical systems employing the inventive reflective LC devices are disclosed in commonly assigned U.S. Provisional Patent Application No. 60/283,592, entitled “DYNAMIC SPECTRAL EQUALIZER AND WAVELENGTH SELECTIVE SWITCH HAVING EXTREMELY LOW POLARIZATION DEPENDENT LOSS AND POLARIZATION MODE DISPERSION” and filed on Apr. 13, 2001 and commonly-assigned U.S. Patent Application No.______ [Attorney Docket No. COR20 P412], entitled “DYNAMIC SPECTRAL EQUALIZER AND WAVELENGTH SELECTIVE SWITCH HAVING EXTREMELY LOW POLARIZATION DEPENDENT LOSS AND POLARIZATION MODE DISPERSION” and filed on even date herewith. The entire disclosures of this applications are incorporated herein by reference.

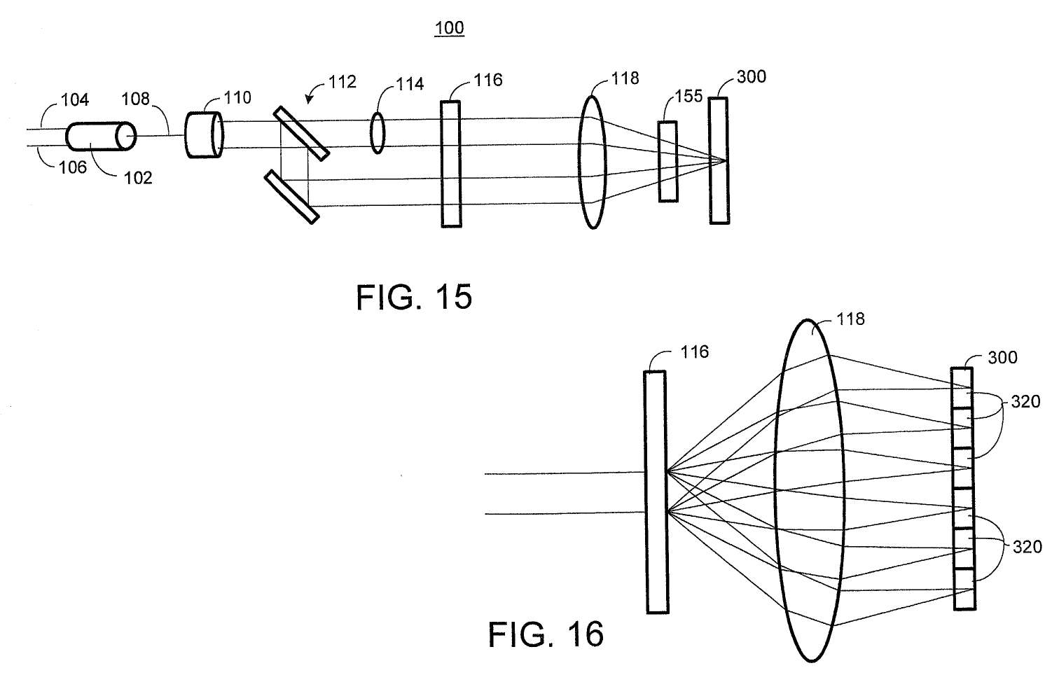

An example of a dynamic spectral equalizer (DSE) utilizing the inventive reflective LC device is shown in FIG. 15. The depicted optical system 100 shown in FIG. 15 includes a circulator 102 coupled to an input fiber 104, an output fiber 106, and a common fiber 108. Input fiber 104 supplies an input composite light beam to circulator 102, which outputs this input composite beam on common fiber 108 with substantially no leakage to output fiber 106. As will be described further below, light beams propagate in both directions through common fiber 108. Light beams that circulator 102 receives via common fiber 108 are output by circulator 102 on output fiber 106 with substantially no leakage to input fiber 104. A lens 110 is provided at the opposite end of common fiber 108 from circulator 102. Lens 110 collimates the input composite light beam supplied from common fiber 108 while focusing collimated beams it receives from its opposite direction and coupling such beams into common fiber 108 for transmission to circulator 102.

Optical system 100 further includes a polarization beam separator/combiner 112, which separates the input composite light beam into two spatially separated, orthogonally polarized first and second composite beamlets. A polarization changer (i.e., a polarizer or retarder) 114 is provided in the path of one of the first and second orthogonally polarized composite beamlets so as to change the polarization of that composite beamlet to be the same as the other composite beamlet. A dispersive element 116 is provided to spectrally disperse the first composite beamlet into a first set of spatially separated component beamlets and to spectrally disperse the second composite beamlet into a second set of spatially separated component beamlets. Each of the component beamlets of the first set corresponds to different communication channels of the first input composite beam as does each component beamlet of the second set. Each component beamlet in the first set has a corresponding component beamlet in the second set at the same wavelength, which together constitute a “channel pair.”

Assuming FIG. 15 is a top plan view of the optical system, FIG. 16 is a side elevational view showing the spatial separation of the component signals by dispersive element 116. It will be appreciated that the polarizations can be separated in the same plane as the dispersion of the dispersive element 116 or in a plane perpendicular to the dispersion of dispersive element 116. F or purposes of example, six different component signals are illustrated. It will be appreciated, however, that the number of component signals will be dependent upon the number of channels carried by the input and output fibers.

As shown in FIGS. 15 and 16, a lens 118 is provided for focusing each of the component beamlets onto a corresponding LC element 320 of reflective LC device 300. As will be described above, each LC element 320 of reflective LC device 300 may be independently activated so as to selectively modulate each of the beamlets so that its proportional power after collection at the output fiber is at the desired value. Furthermore, the optical system is constructed such that the first set of component beamlets is focused onto a reflective surface of LC device 300 at an angle equal to and opposite that of the second set of component beamlets. Thus, as shown in FIG. 15, the first set of component beamlets that is directed at reflective LC device 300 along a first incoming path 124 is reflected to a first outgoing path that is superimposed upon a second incoming path 126 for the second set of component beamlets. Likewise, the second set of component beamlets is reflected by reflective LC device 300 to a second outgoing path superimposed upon the first incoming path 124. The reflected first and second sets of component beamlets are then collimated by lens 118 and directed back to dispersive element 116, which recombines each set of reflected component beamlets into first and second reflected composite beamlets. Polarization changer 114 then changes the polarization of one of the reflected composite beamlets such that the two reflected composite beamlets are orthogonally polarized with respect to one another. Polarization beam separator/combiner 112 then combines the two reflected composite beamlets and it directs the superimposed beamlets to lens 110, which couples the resultant output composite beam to common fiber 108, which in turn supplies the output composite beam to circulator 102, which outputs the output composite beam on output fiber 106.

Polarization beam separator/combiner 112 may be a pair of beam polarizing beamsplitters. Alternatively, other polarization beam separators may be utilized including, but not limited to, birefringent plates, polarizing prisms, and polarization beamsplitting slabs. The polarization changer 114 may be, but is not limited to, a retardation plate, a crystal rotator, or a liquid crystal. Dispersive element 116 may be, but is not limited to, a grating, prism, or grism.

For many applications, it is desirable to have a DSE that can achieve very high extinction blocking (e.g., 35 dB or higher), so that it can block portions of the optical spectrum to a high degree. In practice, limitations on the quality of the components available for the approach illustrated in FIG. 15 may prevent achieving very high extinction when reflective polarization modulators are used as the reflective LC device 300.

A high extinction, extremely low polarization dependent DSE may be attained by providing polarizer 155 between lens 118 and reflective LC device 300. It should be noted that polarizer 155 can be placed anywhere between polarization changer 114 and reflective LC device 300. Polarizer 155 serves to increase the polarization purity of the input beam to reflective LC device 300 and to improve the polarization filtering of the output beam from reflective LC device 300. Polarizer 155 can be, but is not limited to, a polarizing prism, a polymer linear polarizer, a polarcor linear polarizer, or one or more Brewster plates. Reflective LC device 300 can be, but is not limited to, a reflective liquid crystal device or a pixellated birefringent crystal array.

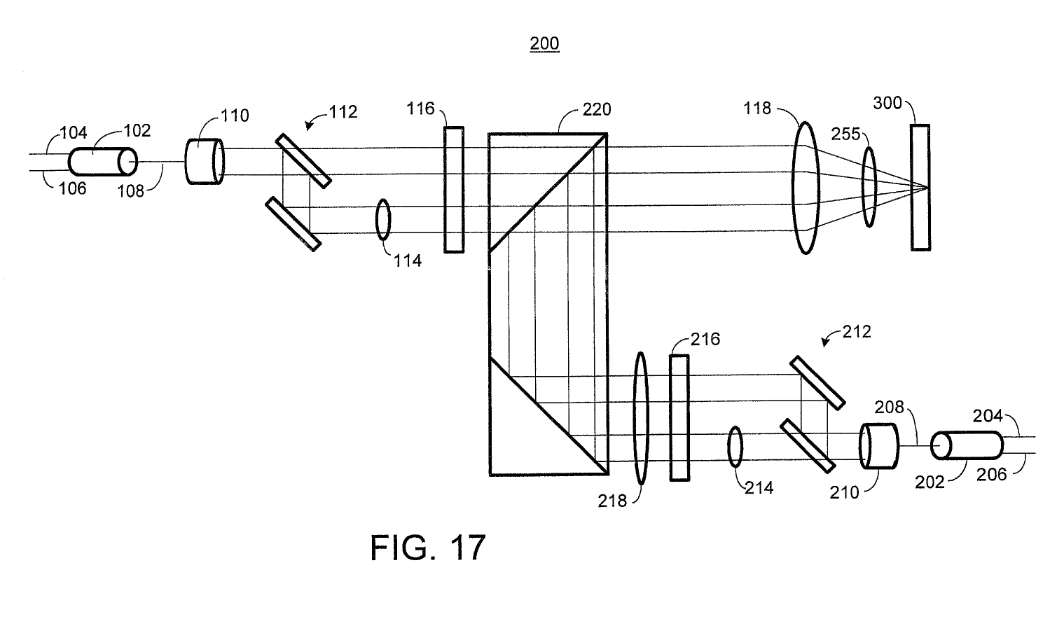

The optical system shown in FIGS. 15 and 16 may be readily converted into a WSS by adding the additional components shown in FIG. 17, which shows an optical system 200 according to a third embodiment of the present invention. Specifically, a second circulator 202 may be added that is coupled to a second input fiber 204, a second output fiber 206, and a second common fiber 208. Similarly, a second lens 210 may be provided between the output of second common fiber 208 and a second polarization beam separator 212. Second circulator 202, second lens 210, and second polarization beam separator 212 may be constructed in an identical fashion to first circulator 102, first lens 110, and first polarization beam separator 112, respectively. Thus, second polarization beam separator 212 separates a second input composite beam received from second input fiber 204 into spatially separated, orthogonally polarized third and fourth composite beamlets.

A second polarization changer 214 is provided in the path of one of the third and fourth composite beamlets so as to change its polarization to be identical to that of the other of these two composite beamlets. A second dispersive element 216 similar to first dispersive element 116 is positioned so as to disperse the third and fourth composite beamlets into respective third and fourth sets of component beamlets.

Unlike the structure shown in FIG. 15, a third polarization changer 218 is provided in the paths of all of the third and fourth sets of component beamlets so as to change the polarization of the beamlets from the second input fiber 204 to have the opposite polarization of those from the first input fiber 104. The oppositely polarized component beamlets from the first and second input fibers are then combined by a polarization beam combiner 220 such that the first set of component beamlets is superimposed with the third set of component beamlets and the second and fourth sets of component beamlets are superimposed upon one another, and then all the beamlet sets are directed at lens 118 in a manner similar to that described above with respect to FIGS. 15 and 16. Lens 118 focuses the sets of beamlets onto a corresponding LC element 320 of reflective LC device 300. The first and third sets of component beamlets are directed at their corresponding LC element 320 along a first incoming path 124 at an angle relative to the reflective surface of reflective LC device 300 so as to have an outgoing path that is superimposed upon the second incoming path 126 of the second and fourth sets of component beamlets. Likewise, the second and fourth sets of component beamlets have an outgoing path that is superimposed on the incoming path 124 of the first and third sets of component beamlets. The outgoing reflected component beamlets are then collimated by lens 118 and subsequently separated by beam polarization combiner 220.

When the optical system 200 shown in FIG. 17 and described above is configured to operate as a WSS, a first input composite beam entering system 200 on first input fiber 104 passes from the first input fiber to circulator 102, which in turn passes the beam to common fiber 108 without substantial leakage into output fiber 106. The first input composite beam on common fiber 108 is then substantially collimated by lens 110 and is then separated by first polarization beam separator 112 into orthogonally polarized first and second composite beamlets. First polarization changer 114 changes the polarization of the second composite beamlet to be the same as the first composite beamlet. The first and second composite beamlets are then incident on dispersive element 116, which outputs first and second sets of component beamlets whose propagation direction is dependent on their wavelength. These first and second component beamlets pass through polarization beam combiner 220 and are focussed by lens 118 such that they are separated spatially at reflective LC device 300 and such that their focus is substantially coincidental with the reflective surface of reflective LC device 300. As noted above, the system is configured such that the first set of component beamlets is directed at reflective LC device 300 along a first incoming path 124 such that they exit reflective LC device 300 along a first outgoing path that is superimposed along the second incoming path 126 of the second set of component beamlets. Likewise, the second set of component beamlets exit reflective LC device along a second outgoing path that is superimposed on the first incoming path 124 of the first set of component beamlets. The sets of component beamlets pass through the lens 118 again and are redirected toward polarization beam combiner 220.

Each LC element 320 may be selectively activated (or deactivated) to rotate the polarization of the corresponding incident component beamlets. When deactivated (or activated), the polarization state of the incident beamlets remains the same. Because there is one LC element 320 provided for each channel (i.e., wavelength), and hence for each pair of component beamlets from the first and second sets, each channel may be selectively and independently affected by relective LC device 300.

For those component beamlets originating from first input fiber 104 that leave reflective LC device 300 with the same polarization, the beamlets pass through polarization beam combiner 220 toward first dispersing element 116 and ultimately toward first output fiber 106. However, for those component beamlets whose polarization was rotated by a modulating element 320 of reflective LC device 300, polarization beam combiner 220 redirects those component beamlets toward third polarization changer 218, dispersive element 216, and ultimately to second output fiber 206. Each dispersive element 116 and 216 recombines the two incident sets of component beamlets into two composite beamlets. The first and second polarization changers then rotate the polarization of one of the two component beamlets so that they are orthogonally polarized and the first and second polarization beam separators 112 and 212 combine the two orthogonally polarized beamlets to form a single output composite beam. The lenses 110 and 210 then focus the output composite beam so as to couple the beam into common fibers 108 and 208. The circulators 102 and 202 then direct the output composite beam toward the first output fiber or the second output fiber, respectively, without substantial leakage to the input fibers.

As will be apparent to those skilled in the art, a second input composite beam on second input fiber 204 passes through the elements described above and is separated into third and fourth sets of component beamlets prior to being redirected by beam polarization combiner 220. For a WSS, the first and third sets of component beamlets are superimposed upon one another exactly when incident upon reflective LC device 300. Likewise, the second and fourth sets of component beamlets are superimposed. Thus, for a given wavelength channel, when the corresponding LC element 320 does not rotate the polarization of the incident beamlets, the beamlet originating from first input fiber 104 exits the optical system on first output fiber 106 and the beamlet originating from second input fiber 204 exits second output fiber 206. However, when the corresponding LC element 320 rotates the polarization of the incident beamlets, the beamlet originating from first input fiber 104 exits the optical system on second output fiber 206 and the beamlet at the corresponding wavelength that originates on second input fiber 204 exits the system on first output fiber 106. Thus, each channel carried on the input fibers may be independently switched.

The optical system 200 may be modified in a number of different ways so as to perform the function of a dual DSE. In such a dual DSE, the reflective LC device could still be a reflective polarization modulator, however, it may be tuned to an intermediate value. In such a system, the input beams on first input fiber 104 would always exit first output fiber 106 unless they were effectively extinguished by reflective LC device 300. Similarly, second input beams on second input fiber 204 would always be output on second output fiber 206 unless effectively extinguished.

Another way to create a dual DSE using optical system 200 shown in FIG. 17 would be to align lenses 110 and 210 such that the beams that originated from input fibers 104 and 204 are not substantially superimposed at reflective LC device 300. This allows the two inputs to be modulated independently and reduces to near zero the effect of discarded power from the attenuation of one input on the signal to noise ratio of the signal from the other input.

Polarization beam combiner 220 may be a polarizing beam-combining prism such as that depicted in FIG. 17. For ease of presentation, the depicted polarizing beam-combining prism has been illustrated as producing a spatial offset and a 180° direction change for incoming beamlets that originated from second input fiber 204. In practice, any polarization beam combiner that produces a spatial or angular offset that is sufficient to allow the incoming beams from the first and second input fibers to be superimposed onto each other can be used for this purpose. Such polarization beam combiners include, but are not limited to, birefringent plates, polarizing prisms, and polarization beamsplitting slabs. For some polarization modulators, it may be desirable that the incoming beamlets all share substantially the same sets of orthogonal polarizations. In these cases, it may be advantageous that the surface normal of the polarizing surface of the polarization beam-combining prism be substantially parallel to the plane of dispersion of the dispersive elements.

When reflective LC devices are utilized that have an interface between a birefringent material and a non-birefringent material at or near the reflection plane, this interface causes a back reflection that has a component that is orthogonal to the back reflections from all interfaces between non-birefringent materials. Extinction may often be limited by this orthogonal component.

A high extinction, extremely low polarization dependent WSS or dual DSE may be attained by providing an additional retarder 255 between lens 118 and reflective LC device 300. When the value of additional retarder 255 between lens 118 and reflective LC device 300 is nearly, but not exactly, one-quarter wave for the wavelengths used in the device, the voltage of the reflective LC device (particularly when implemented with a liquid crystal device) can be tuned in such a way that the component of the back reflection off of the birefringent interfaces that is orthogonal to all other back reflections can be substantially eliminated. Additionally, because retarder 255 is nearly one-quarter wave, all other back reflections for the output that return to the fiber from which it was received are substantially eliminated by the retarder 255. In practice, this method of compensation enables isolation of substantially greater than 40 dB to be consistently achieved. It should be noted that additional retarder 255 can also be disposed between lens 118 and polarization beam combiner 220 to achieve the same result. It is also noted that additional retarder 255 can be used in the single DSE embodiment shown in FIG. 17 to improve its isolation to substantially greater than 40 dB.

It will become apparent to those skilled in the art that various modifications to the preferred embodiment of the invention as described herein can be made without departing from the spirit or scope of the invention as defined by the appended claims.

The invention claimed is:

1. An optical system comprising:
a reflective liquid crystal device having a plurality of independently activated liquid crystal elements; and
an optical element for directing a plurality of input light beams at said reflective liquid crystal device such that each input light beam impinges upon one of said liquid crystal elements,
wherein each liquid crystal element of said reflective liquid crystal device comprises:
a transparent first electrode;
a reflective second electrode spaced apart from said first electrode; and
a liquid crystal medium disposed between the first and second electrodes, and
wherein said liquid crystal elements are independently operable to change between half-wave and zero retardation states in response to an applied voltage.

2. The optical system of claim 1 and further comprising a first polarizer for passing an input light beam at a first polarization prior to impinging upon said reflective liquid crystal device.

3. The optical system of claim 2 and further comprising a second polarizer for passing a light beam reflected from said reflective liquid crystal device at a second polarization.

4. The optical system of claim 3, wherein the second polarization is orthogonal to the first polarization.

5. The optical system of claim 3, wherein the second polarization is parallel to the first polarization.

6. The optical system of claim 2 and further comprising a compensation plate disposed in front of said reflective liquid crystal device for compensating for residual birefringence of said reflective liquid crystal device when a high voltage is applied.

7. The optical system of claim 2 and further comprising a quarter-wave plate disposed in front of said reflective liquid crystal device.

8. A reflective liquid crystal device for use in an optical communication system in which a plurality of input light beams are directed at the liquid crystal device, the liquid crystal device comprising:
a transparent first substrate having a first surface upon which the at least one light beam is incident and a second surface opposite the first surface;
a transparent first electrode layer supported on the second surface of said first substrate;
a second substrate having first and second surfaces, the first surface of said second substrate being opposed to the second surface of said first substrate;
a second electrode layer supported on the first surface of said second substrate, wherein said second electrode layer is either reflective or transparent if a reflective layer is otherwise supported by one of the surfaces of said second substrate;
a first alignment layer supported on the second surface of the first substrate;
a second alignment layer supported on the first surface of the second substrate; and
a liquid crystal medium disposed between the first and second electrode layers,
wherein at least one of said first and second electrode layers is patterned so as to define a plurality of independently activated liquid crystal elements each sized to receive one of the input light beams, wherein said liquid crystal elements are operable to change between half-wave and zero retardation states in response to an applied voltage.

9. The reflective liquid crystal device of claim 8, wherein said second electrode layer is reflective.

10. The reflective liquid crystal device of claim 8, wherein the second electrode layer is transparent and the device further comprises a reflective layer supported by either the first or second surface of said second substrate.

11. The reflective liquid crystal device of claim 8, wherein said second substrate is transparent.

12. The reflective liquid crystal device of claim 8, wherein both said electrode layers are patterned.

13. The reflective liquid crystal device of claim 8, wherein the liquid crystal material has a positive dielectric anisotropy.

14. The reflective liquid crystal device of claim 13, wherein both said alignment layers provide homogenous alignment of the molecules of said liquid crystal medium when no voltage is applied to the electrodes.

15. The reflective liquid crystal device of claim 14, wherein, when a voltage is applied to the electrodes, the molecules align perpendicular to the second surface of said first substrate and to said first surface of said second substrate.

16. The reflective liquid crystal device of claim 15, wherein the thicknesses of the layers of the device are selected such that the polarization of an incident light beam is maintained when a voltage is applied to the electrodes and, when no voltage is applied to the electrodes, the polarization of an incident beam is rotated 90 degrees.

17. The reflective liquid crystal device of claim 13, wherein, when no voltage is applied to the electrodes, said first alignment layer provides homeotropic alignment of the molecules of said liquid crystal medium that are proximate said first alignment layer, and said second alignment layer provides homogeneous alignment of the molecules of said liquid crystal medium that are proximate said second alignment layer.

18. The reflective liquid crystal device of claim 17, wherein, when a voltage is applied to the electrodes, the molecules align perpendicular to the second surface of said first substrate and to said first surface of said second substrate.

19. The reflective liquid crystal device of claim 18, wherein the thicknesses of the layers of the device are selected such that the polarization of an incident light beam is maintained when a voltage is applied to the electrodes, and, when no voltage is applied to the electrodes, the polarization of an incident beam is rotated 90 degrees.

20. The reflective liquid crystal device of claim 8, wherein the liquid crystal material has a negative dielectric anisotropy.

21. The reflective liquid crystal device of claim 20, wherein both said alignment layers provide homeotropic alignment of the molecules of said liquid crystal medium when no voltage is applied to the electrodes.

22. The reflective liquid crystal device of claim 21, wherein, when a voltage is applied to the electrodes, the molecules align parallel to the second surface of said first substrate and to said first surface of said second substrate.

23. The reflective liquid crystal device of claim 22, wherein the thicknesses of the layers of the device are selected such that the polarization of an incident light beam is maintained when no voltage is applied to the electrodes and, when a voltage is applied to the electrodes, the polarization of an incident beam is rotated 90 degrees.

24. The reflective liquid crystal device of claim 8, and further comprising a protective layer supported by one of the second surface of said first substrate and the first surface of said second substrate, said protective layer preventing electrons from flowing between the electrodes and through the liquid crystal medium.

25. The reflective liquid crystal device of claim 8, and further including a seal disposed between said first and second substrates to constrain said liquid crystal medium.

26. The reflective liquid crystal device of claim 8, wherein said alignment layers are disposed between said electrode layers and said substrates.

27. An optical communication system comprising:
a reflective liquid crystal device having a plurality of independently activated liquid crystal elements; and
an optical element for directing a plurality of input light beams at said reflective liquid crystal device such that each input light beam impinges upon one of said liquid crystal elements,
wherein said reflective liquid crystal device comprises:
a transparent first substrate having a first surface upon which a plurality of light beams are incident and a second surface opposite the first surface;
a transparent first electrode layer supported on the second surface of said first substrate;
a second substrate having first and second surfaces, the first surface of said second substrate being opposed to the second surface of said first substrate;
a second electrode layer supported on the first surface of said second substrate, wherein said second electrode layer either is reflective or is transparent if a reflective layer is otherwise supported by one of the surfaces of said second substrate;
a first alignment layer supported on the second surface of the first substrate;
a second alignment layer supported on the first surface of the second substrate;
a liquid crystal medium disposed between the first and second electrode layers; and
wherein at least one of said first and second electrode layers is patterned so as to define said plurality of independently activated liquid crystal elements, wherein said liquid crystal elements are independently operable to change between half-wave and zero retardation states in response to an applied voltage.
